(19) United States
(12) Patent Application Publication
(10) Pub. No.: US 2026/0350982 A1
(43) Pub. Date: Nov. 5, 2026

(54) SUGARCANE PLANTER ROW UNIT DOCUMENTATION SYSTEM

(71) Applicant: Deere & Company, Moline, IL (US)

(72) Inventors: John A. Dighton, Napoleonville, LA (US); Zachary A. Ritchie, West Des Moines, IA (US); Michael L. Halbrook, Thibodaux, LA (US)

(21) Appl. No.: 19/198,622

(22) Filed: May 5, 2025

(51) Int. Cl. G06V 20/10; A01C 5/06; A01C 14/00; F21V 14/04; F21W 107/10; F21W 131/40; G06V 10/141

(52) U.S. Cl. CPC G06V 20/188; A01C 5/062; A01C 14/00; F21V 14/04; G06V 10/141; F21W 2107/10; F21W 2131/40

(57) ABSTRACT

A system and for planting cut sugarcane in a field and for identifying the cut sugarcane planted in a trench. The system includes a hopper configured to carry the cut sugarcane, a trencher suspended from a frame of the sugarcane planter and configured to form a trench in the field, and a dispensing chute operatively connected to the hopper. The dispensing chute is configured to dispense the cut sugarcane from the hopper to the trench. An imaging system is operatively coupled to the frame of the sugarcane planter, wherein the imaging system includes a field of view directed toward the cut sugarcane dispensed in the trench and located within the trencher. A chamber is disposed at the trencher, wherein the chamber is configured to reduce ambient light located within the field of view of the imaging system.

### FIELD OF THE DISCLOSURE

The present disclosure relates to a sugarcane planter and more particularly to an imaging system for a planter row unit of the sugarcane planter.

### BACKGROUND

A sugarcane harvester severs sugarcane plants from the ground with a base cutter assembly and transports the severed plants to a set of chopping drums that chop the severed plant into billets. The billets are sent through a cleaning arrangement to separate the billets from non-billet material, i.e. crop residue, such as leaves, dirt, and other trash. Passing through the cleaning system, the billets are then discharged, for example, from the harvester to be transported by or stowed in a vehicle.

Some billets are reserved to seed the ground for a next planting season. Planters typically include a large storage bin, known as a hopper, and a dispensing chute that receives billets from the storage bin. The dispensing chute deposits the billets in a trench formed by a trencher. Once the billets are deposited, a closer, such as a disc, is used to cover the trench and the billets with soil to complete the planting.

### SUMMARY

In one implementation, there is provided a system for identifying the planting of sugarcane in a field by a sugarcane planter. The system includes a hopper configured to carry cut sugarcane, a trencher suspended from a frame of the sugarcane planter and configured to form a trench in the field, and a dispensing chute operatively connected to the hopper. The dispensing chute is configured to dispense the cut sugarcane from the hopper to the trench. An imaging system is operatively coupled to the frame of the sugarcane planter, wherein the imaging system includes a field of view directed toward the cut sugarcane dispensed in the trench. A chamber is disposed at the trencher and is chamber configured to reduce ambient light located within the field of view of the imaging system.

In some implementations, the system includes a light source configured to emit light to illuminate the field of view.

In some implementations, the system includes wherein the chamber has at least one movable light deflector, wherein the at least one movable light deflector is configured to move in response to contact with the field or contact with the cut sugarcane dispensed in the trench.

In some implementations, the system includes wherein the at least one movable light deflector includes a first movable light deflector and a second movable light deflector, wherein the first movable light deflector is located toward a front portion of the field of view and the second movable light deflector is located towards a back portion of the field of view.

In some implementations, the system includes wherein the imaging system is coupled to the frame of the sugarcane planter.

In some implementations, the system includes wherein the imaging system includes an imaging device having a field of view, the imaging device configured to image the cut sugarcane.

In some implementations, the system includes wherein the chamber comprises a light box fixedly coupled to the imaging device, wherein the light box includes one or more sides of the trencher.

In some implementations, the system includes wherein the light box includes at least one movable light deflector, wherein the at least one movable light deflector is configured to move in response to contact with the field for with the cut sugarcane dispensed in the trench.

In some implementations, the system includes a controller operatively connected to the imaging device and configured to receive from the imaging device still images or moving images of the sugarcane crop located in the field of view.

In some implementations, the system includes wherein the imaging system includes a sugarcane crop identifier coupled to the controller, wherein the crop identifier is configured to identify features of the sugarcane crop located in the field of view.

In another implementation, there is provided a method of identifying, with an imaging device, the planting of sugarcane billets deposited in a field by a sugarcane planter. The method includes: cutting a trench in a field with a trencher; depositing the sugarcane billets into the trench from a hopper of the sugarcane planter; adjusting an amount of ambient light in the trench; imaging, with the adjusted amount of ambient light, the sugarcane deposited in the trench as the hopper moves along the field to provide one or more images of the deposited sugarcane; and identifying one or more planting characteristics of the deposited sugarcane billets based on the provided one or more images.

In some implementations, the method includes identifying a quantity of sugarcane billets planted in a trench over a predetermined length of the trench.

In some implementations, the method includes identifying a planting rate of the sugarcane billets based on the provided one or more images.

In some implementations, the method includes wherein imaging the sugarcane includes imaging the sugarcane with an imaging device having a field of view configured to image a portion of the trench.

In some implementations, the method includes wherein adjusting the amount of ambient light at the trench includes shading the amount of ambient light received by the imaging device.

In some implementations, the method includes wherein shading the amount of ambient light received by the imaging device includes using a movable light deflector configured to deflect ambient light from the imaging device.

In some implementations, the method includes imaging the sugarcane deposited in the trench with a light source directed to the field of view.

In a further implementation, there is provided an agricultural machine for planting sugarcane in a field. The agricultural machine includes a power mover, a hopper, coupled to the power mover, wherein the hopper is configured to carry cut sugarcane, and a trencher suspended from a frame of the agricultural machine and configured to form a trench in the field. A dispensing chute is operatively connected to the hopper, wherein the dispensing chute is configured to dispense the cut sugarcane from the hopper to the trench. An imaging system is supported by the trencher, wherein the imaging system includes a field of view within the trencher and the field of view is directed toward the cut sugarcane dispensed in the trench.

In some implementations, the agricultural machine includes wherein the imaging system includes an imaging device and a light source configured to emit light to illuminate the field of view.

In some implementations, the agricultural machine includes wherein the imaging system has at least one movable light deflector, wherein the at least one movable light deflector is configured to move in response to contact with the field or in response to cut sugarcane dispensed in the trench.

### BRIEF DESCRIPTION OF THE DRAWINGS

FIG. 1 is a perspective view of a sugarcane planting machine,

FIG. 2 is a side view of the planting machine of FIG. 1.

FIG. 3 is a sugarcane billet of the crop material of the planting machine of FIG. 1.

FIG. 4 illustrates an imaging system configured to receive and to image sugarcane billets being planted.

FIG. 5 illustrates a partial view of the imaging system including a trencher and an imaging assembly.

FIG. 6 illustrates a perspective view of the imaging assembly.

FIG. 7 illustrates one implementation of a control system for imaging sugarcane billets.

### DETAILED DESCRIPTION

Before any implementations of the disclosure are explained in detail, it is to be understood that the disclosure is not limited in its application to the details of construction and the arrangement of components set forth in the following description or illustrated in the accompanying drawings. The disclosure is capable of supporting other implementations and of being practiced or of being carried out in various ways. Also, it is to be understood that the phraseology and terminology used herein is for the purpose of description and should not be regarded as limiting.

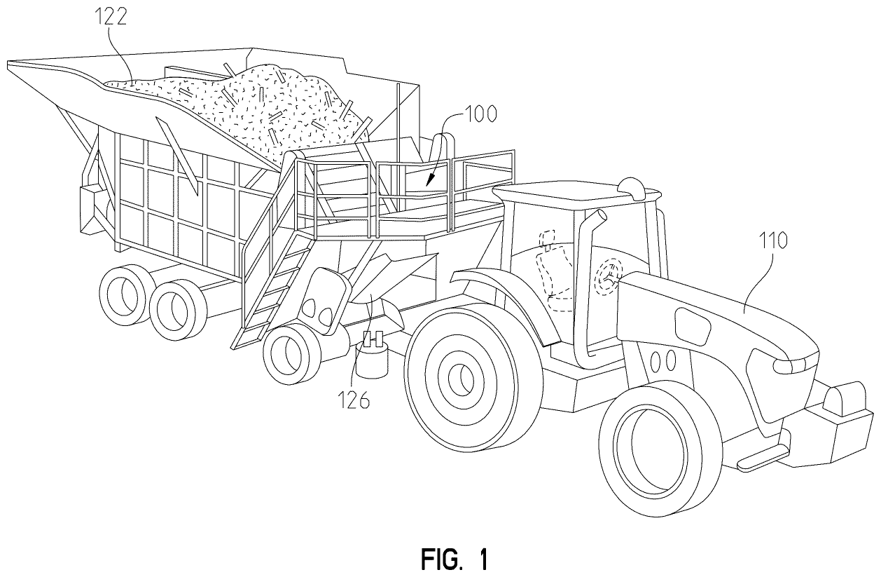

FIG. 1 illustrates a planting machine 100 that is pulled by a tractor 110 during operation. The planting machine 100 is operatively connected to the tractor 110 to pull the planting machine 100 across a field during operation. While the illustrated planting machine 100 is pulled by the tractor 110, it is understood that in other implementations the planting machine 100 may be self-propelled. In other implementations, an autonomous machine including a propulsion system having a power mover, such as an engine, is considered. An entirely self-contained autonomous harvester is also contemplated. In addition, the harvester 100 may be a remotely operated harvester having a remotely located operator.

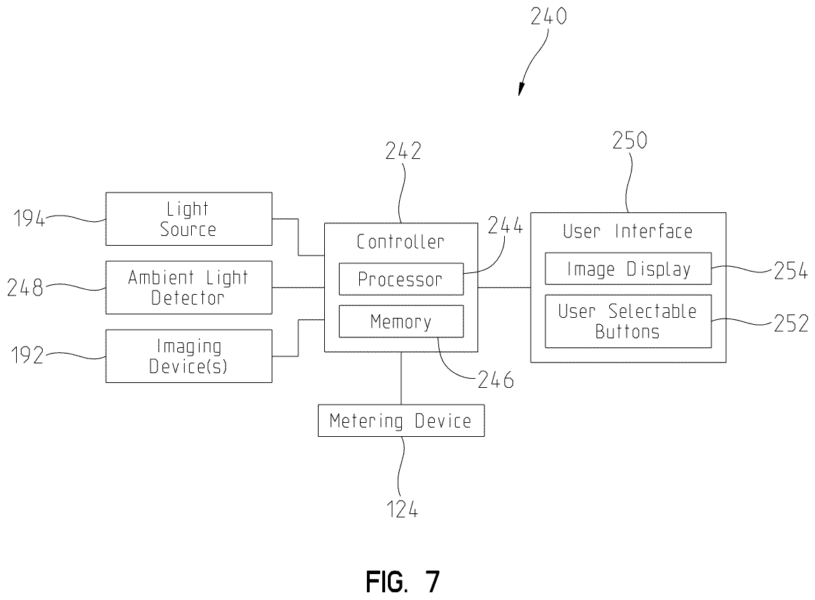

The planting machine 100 includes a hopper 122, a metering device 124 (see FIG. 7), and a planting chute 126. The hopper 122 is a container for storing bulk crop material such as, for example, sugarcane billets (discussed below). The hopper 122, in turn, is configured to feed the crop material to the metering device 124 whereby the metering device 124 delivers the crop material at a pre-determined rate to the planting chute 126. The planting chute 126 is configured to discharge and distribute the crop material output by the metering mechanism 124 to a surface of a field in a pre-determined pattern or manner. For example, in some implementations, as the planting machine 100 is pulled across a field, the planting machine 100 opens a trench (or furrow) and the planting chute 126 deposits the crop material from the hopper 122 into the trench, and, in some cases, closes the trench. Although the example of FIG. 1 shows a single planting chute 126, in other implementations, the planting machine 100 may include more than one planting chute 126. In still other implementations, the planting machine 100 may include multiple independently controlled planting assemblies, with each assembly having an independently controlled metering mechanism and planting chute while being pulled at a common speed by a single tractor 110. While one planting chute 126 is shown, which is known as a single row unit, in other implementations, the planting machine 100 includes more that one row unit.

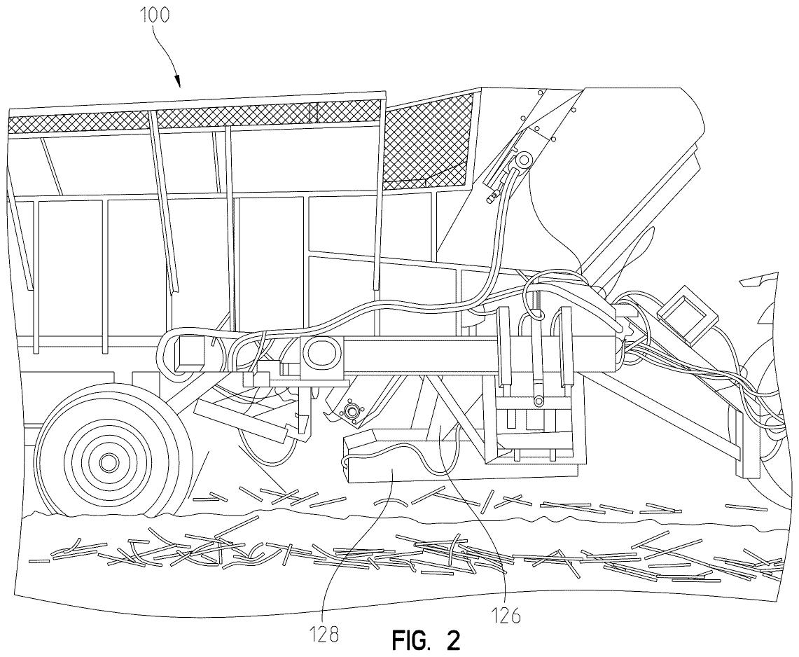

FIG. 2 illustrates a side view of the planting machine 100 that is pulled by the tractor 110 during operation. In this example, the planting machine 100 includes an imaging system 128. The imaging system 128 includes a field of view configured to capture video data that includes identifying and tracking individual elements and attributes of crop material that is distributed during operation of the planting machine 100 and which is subsequently planted. In some implementations, the imaging system is positioned so that all crop material distributed by the planting machine 100 may pass through the field of view of the imaging system 128. In other implementations, the imaging system 128 may be positioned so that a known proportion (e.g., 25%, 50%, 75%) of the volume of crop material distributed by the planting machine 100 will pass through the field of view of the imaging system 128.

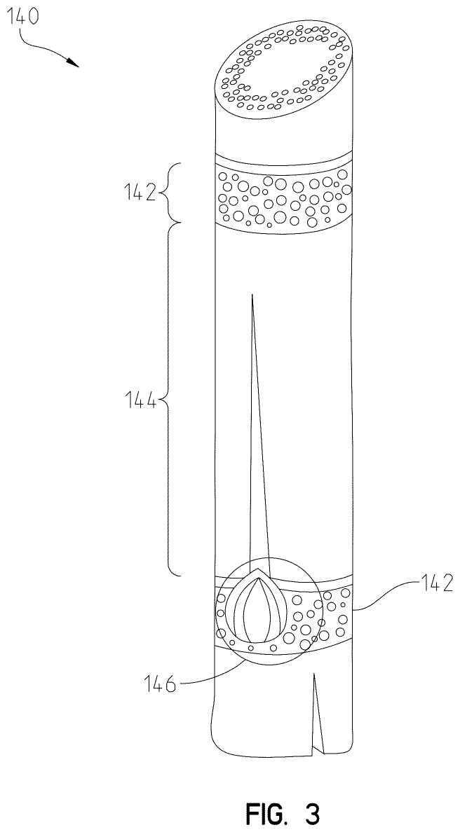

FIG. 3 illustrates an example of a sugarcane billet 140 of crop material that is planted during operation by planting machine 100. Each billet 140, in turn, includes one or more nodes 142, one or more internodes 144 extending between adjacent nodes 142, and one or more eyes 146 located on a corresponding node 142. One of the eyes 146 is illustrated in an enlarged view. Together, the nodes 142, internodes 144, and eyes 146, of each individual billet 140 define a plurality of attributes of a single billet 140. The attributes of at least some of the single billets 140 being planted are imaged by the imagined system 128. Such individual attributes may include, but are not limited to, the overall billet length (e.g., the distance between the two distal ends of the billet 140), the internodal length (e.g., the length between a particular set of adjacent nodes 142), the average internodal length (e.g., the average of all internodal lengths found on an individual billet 140), the node number (e.g., the number of nodes 142 found on a particular billet 140), the eye number (e.g., the number of eyes 146 found on a particular billet 140), and the billet diameter (e.g., the average diameter of a particular billet 140).

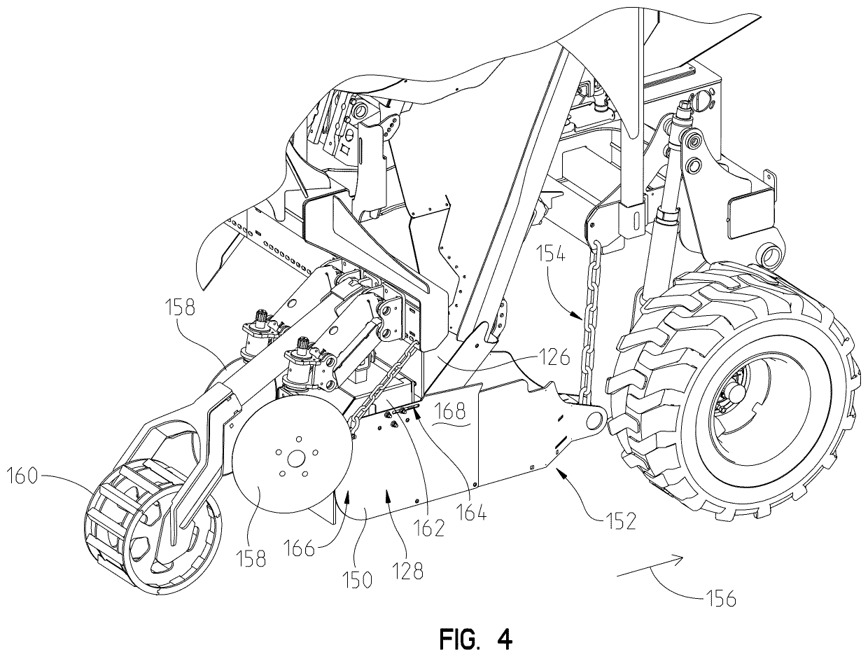

FIG. 4 illustrates the imaging system 128 which is configured to receive and to image billets 140 from the hopper 122 for planting. Billets 140 are directed by the planting chute 126 and fall into a trencher 150 having a front end or front portion 152 suspended from a frame of the planting machine 100 by a chain 154. The use of the chain 154 enables the trencher 150 to float relative to the planting machine 100. In one embodiment, the imaging device 192 is fixed to the trencher 150 and moves with the trencher 150 as it moves with respect to the frame of the planning machine. In another embodiment, the imaging device 192 is fixed with respect to the frame and the trencher 150 moves with respect to the imaging device 192. The front end 152 includes a narrow profile that provides a leading portion of the trencher 150 that act as an opener for opening the trench. As the planting machine 100 moves in a forward direction 156, the front end 152 starts forming a trench in the soil where billets 140 are deposited as the planting machine 100 moves. As the trench is opened, up the billets 140 fall to the ground within the formed trench. After being placed in the trench, closers 158 close the trench and a rotating wheel or tamper 160 applies pressure to the soil to further close the trench.

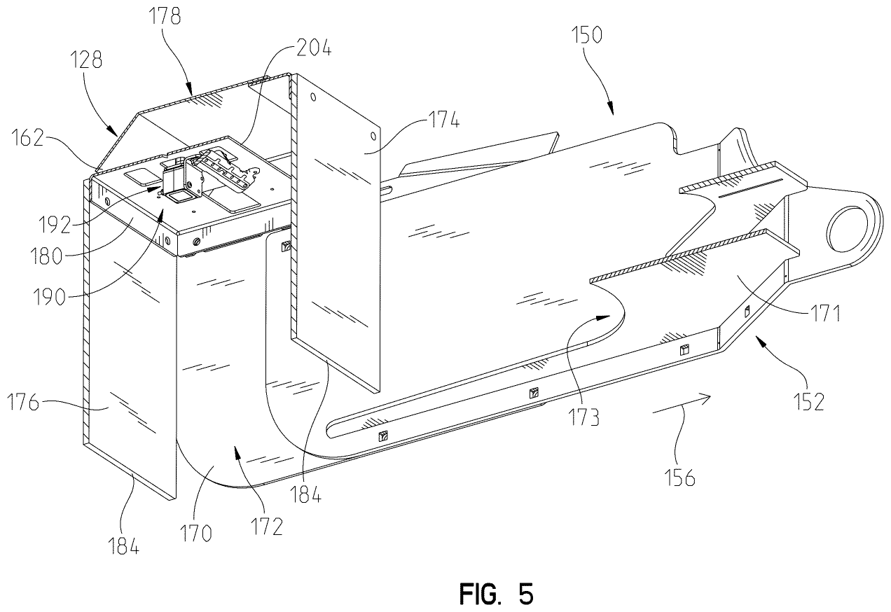

As seen in FIG. 4 the imaging system 128 includes the trencher 150 and an imaging assembly 162. The imaging assembly 162 is located at a top portion 164 of the trencher 150 and toward a back end of back portion 166 of the trencher 150. The imaging assembly 162, in one implementation, includes a first side 168 and a second side 170, wherein the second side is shown in a partial view of the trencher 150 and the imaging assembly 162 in FIG. 5. The imaging assembly 162 is configured to image the billets under a substantially consistent illumination condition.

As the imaging system 128 moves in the direction 156 as seen in FIG. 5, the billets 140 fall to the ground and are generally directed toward the trench by the sides of the trencher 150 and a guide plate 171 which includes a cutout 173. Only a portion of the guide plate 171 is illustrated and the cutout 173 in the guide plate 171 defines a generally oblong cutout. The guide plate 171 is configured to provide structural integrity to the trencher 150. In addition, the cutout 173 directs the billets at a predefined path in the trench, which positions the billets in a field of view, within the trencher 150, of the imaging system 128. As the billets 140 are deposited in the trench, forward movement of the trencher 150 moves an imaging chamber 172 over the deposited billets 140. The imaging chamber 172, in one implementation, is defined by the first side 168 of FIG. 4, the second side 170, a first movable partition 174, a second movable partition 176, and a top side 178. The imaging assembly 162 is located within or at a top region of the chamber 172 and is supported at least in part by a bracket 180. The top side 178 acts as guard or a shield for the imaging assembly 162.

In one implementation, each of the first movable partitions 174 and the second movable partition 176 are formed of a flexible material, such as rubber. Each of the first movable partition 174 and the second movable partition 176 include a sufficient length such that each partition may come into contact with the soil of the trench and/or the billets 140 located in the trench. Bottom ends 184 of each of the first movable partition 174 and the second movable partition 176 may make contact with the soil or billets as the trencher 150 moves along the ground. Each of the first movable partition 174 and the second movable partition 176 act as light deflectors to deflect light away from the chamber 172. A top portion of the movable partitions 174 and 176 are fixed and the bottom portion is not fixed and is free to move.

The chamber 172 of the imaging assembly 162 provides a substantially closed light box formed by the first side 168, the second side 170, the first movable partition 174, the second movable partition 176, and one or both of the top side 178 and the imaging assembly 162. The light box restricts any ambient light, and/or provides a shade for any ambient light, which may enter the light box as the trencher 150 moves along the ground. By restricting ambient light, the imaging assembly 162 may operate under a substantially consistent illumination condition to provide consistently illuminated images of billets for analysis.

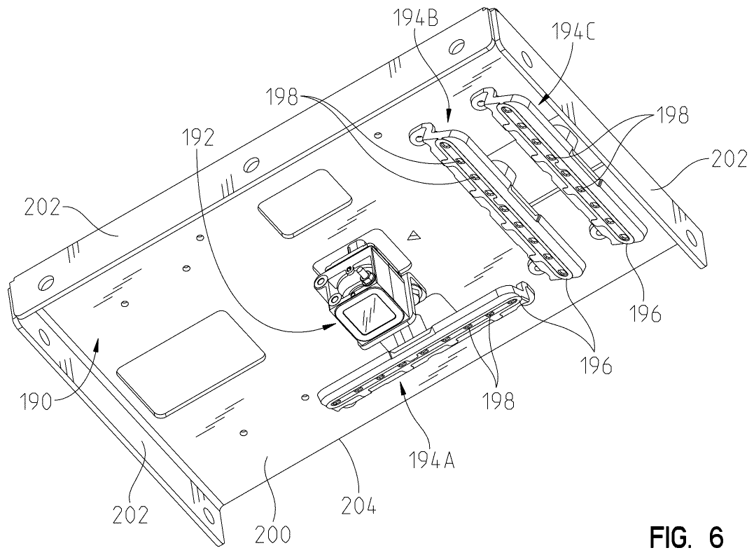

As seen in FIGS. 5 and 6, the imaging assembly 162 includes a support 190 which supports an imaging device 192 and one or more illumination devices 194A, 194B, and 194C. In one implementation, the imaging device 192 includes black and white, red, green, blue (RGB), or multispectral cameras configured as either mono or stereo pairs. In some implementation, each of the illumination devices 194A, 194B, and 194C include a light bar 196 supporting one or more light emitting diodes (LED) 198 which transmit light in response to power supplied by a power supply (not shown). As seen in FIG. 6, the support 190 includes a substantially planar top 200 and three sides 202, each of which are inclined with respect to the top 200, and which form the bracket 180 for coupling to the imaging assembly 162 to sides of the trencher 150. Support 190 includes a front edge 204, which does not include an inclined side. The lack of the inclined sides enables light provided by at least the illumination device 194A to more completely illuminate the light box without obstruction by a side, such as side 202.

As seen in FIG. 6, the LEDs 198 of each of the illumination devices 194 is inclined with respect to the substantially planar top 200, which directs light bar illumination at an angle with respect to the planar top 200. Illumination device 194A is directed in a forward position toward a field of view directed forward of the imaging device 192 and toward the front end 152 of the trencher. Illumination devices 194B and 194C are directed toward a middle field of view that may be captured by the imaging device 192. In one implementation, the illumination devices 194B and 194C are located on one side of the substantially planar top 200. In another implementation, the illumination device 194 B remains at its current location and illumination device 194C is moved to an opposite side of the imaging device 192. Other locations of the imaging devices 194 are contemplated. In addition, other types of imaging devices are contemplated including incandescent of halogen bulbs. In other implementations, the illumination devices selected for use are rough service illumination devices. The location of the imaging device 192 and the illumination devices 194 are arranged to provide a fixed frame of reference that is looking down toward the deposited billets. In another implementation, the imaging device 192 is directed toward the chute 126 that delivers billets 140 to the trench.

FIG. 7 illustrates one implementation of a control system 240 for imaging sugarcane billets 140 that are deposited in the trench. The imaging system 240 includes a controller 242 configured to identify and document billet characteristics, planting conditions, and planting operations. In some implementations, the identification and documentation of billet planting conditions are used to modify or improve billet planting procedures and the operation of the planting machine 100 and/or the tractor 110. Billet characteristics includes but are not limited to the billet characteristics illustrated and described for the billet of FIG. 3. Billet planting conditions may include a quantity of sugarcane billets imaged in the field of view and/or a planting rate of planting or depositing the billets in the trench. Planting conditions may also includes the number of billets planted within a portion of the trench to identify a number of billets planted over a predetermined portion of the trench. Images, provided by the imaging devices, are transmitted to the controller 242 where the images are processed to identify billet characteristics, configurations, and billet planting. Based on an image analysis software resident at the controller, the controller identifies the billet conditions. In one implementation, a sugarcane crop identifier, coupled to the controller, configured to identify features of the sugarcane crop located in the field of view.

The controller 242, in different implementations, is a single controller or a plurality of controllers, which may be operatively coupled to one another. As shown in FIG. 7, the controller 242 includes a processor 244 and a memory 246 configured to execute instructions (i.e. algorithmic steps) stored in the memory 246. The controller 242 may be operatively coupled (i.e. hardwired or connected wirelessly) to other components of the planting machine 100 or the tractor 110. If hardwired, the controller 242 may be connected to the components via wires, and if connected wirelessly, the controller 242 may be connected to the components via Wi-Fi, Bluetooth, NFC, or other known means of wireless communication. Thus, the controller 242 may be positioned on the planting machine 100 or the tractor 110 or both. The controller 242 may also be positioned remotely therefrom, such as in a cloud system.

The controller 242 may be operatively connected to one or more imaging devices 192, one or more light sources 194, and an ambient light detector 248. In one implementation, the ambient light detector 242 detects ambient light in the light box and an ambient light signal is transmitted to the controller to adjust light intensity of the light sources 194. The imaging device or devices 192 are positioned generally along a longitudinal centerline of the trencher 150 to capture electronic images of the deposited billets 140, which includes but is not limited to complete billets, partial billets, and crop residue being deposited with the billets.

The controller 242 executes or otherwise relies upon computer software applications, components, programs, objects, modules, or data structures, etc. Software routines, resident in the included memory 246 or other memory, are executed in response to the signals received from the connected devices. In other implementations, the computer software applications are located in the cloud. The executed software includes one or more specific applications, components, programs, objects, modules or sequences of instructions typically referred to as “program code”. The program code includes one or more instructions located in memory and other storage devices that execute the instructions that are resident in memory, which are responsive to other instructions generated by the system, or which are provided by a user interface 250. The processor is configured to execute the stored program instructions.

The controller 242 is operatively connected to the user interface 250, which in one implementation, is located in a cab of the tractor 110. Other locations of the user interface are contemplated, including a remotely located user interface for an autonomous sugarcane cane harvester. The user interface 250 is operatively coupled to the controller 242 such that a user operates functions through user selectable button 252 of the user interface 250. The user interface 250 includes one or more user inputs identified by the user selectable buttons 252 for the operator to adjust functioning of the planting machine 100 or the tractor 110. For instance, in one implementation, the user interface includes an image display 254 which receives either moving images or still images provided by the imaging device(s) 192. Based on the provided images, the operator may speed up or slow down the tractor 110 to improve the planning of billets. In another implementation, the operator may adjust the metering device 124 to speed up or slow down the depositing of billets, provided the by metering device 124, to the trench.

In some implementation, images provided by the imaging device 192 are used to identify and to locate a position of each of the eyes 146. The eyes 146 may be documented or the number of eyes may be counted by the controller 242. In some implementations, images of the billets 140 may be used to identify the quality of the seed cane or billets to predict a survivability of the seed cane and whether the quality is sufficient to provide a viable sugarcane plant. In a further implementation, the volume of billets 140 may be measured by utilizing a three-dimensional imaging device configured to make three-dimensional measurements.

While exemplary implementations incorporating the principles of the present disclosure have been described herein, the present disclosure is not limited to such implementations. Instead, this application is intended to cover any variations, uses, or adaptations of the disclosure using its general principles. Further, this application is intended to cover such departures from the present disclosure as come within known or customary practice in the art to which this disclosure pertains.

1. A system for identifying the planting of sugarcane in a field by a sugarcane planter, the system comprising:
a hopper configured to carry cut sugarcane;
a trencher suspended from a frame of the sugarcane planter and configured to form a trench in the field;
a dispensing chute operatively connected to the hopper, the dispensing chute configured to dispense the cut sugarcane from the hopper to the trench;
an imaging system operatively connected to one of the frame or to the trencher of the sugarcane planter, wherein the imaging system includes a field of view directed toward the cut sugarcane dispensed in the trench; and
a chamber disposed at the trencher, the chamber configured to reduce ambient light located within the field of view of the imaging system.

2. The system of claim 1 further comprising a light source configured to emit light to illuminate the field of view.

3. The system of claim 2 wherein the chamber includes at least one movable light deflector, wherein the at least one movable light deflector is configured to move in response to contact with the field or to contact the cut sugarcane dispensed in the trench.

4. The system of claim 3 wherein the at least one movable light deflector includes a first movable light deflector and a second movable light deflector, wherein the first movable light deflector is located toward a front portion of the field of view and the second movable light deflector is located towards a back portion of the field of view.

5. The system of claim 2 wherein the imaging system is coupled to the frame of the sugarcane planter.

6. The system of claim 5 wherein the imaging system includes an imaging device having a field of view, the imaging device configured to image the cut sugarcane.

7. The system of claim 6 wherein the chamber comprises a light box fixedly coupled to the imaging device, wherein the light box includes one or more sides of the trencher.

8. The system of claim 7 wherein the light box includes at least one movable light deflector, wherein the at least one movable light deflector is configured to move in response to contact with the field or in response to contact with the cut sugarcane dispensed in the trench.

9. The system of claim 6 further comprising a controller operatively connected to the imaging device and configured to receive from the imaging device still images or moving images of the sugarcane crop located in the field of view.

10. The system of claim 9 wherein the imaging system includes a sugarcane crop identifier coupled to the controller, wherein the crop identifier is configured to identify features of the sugarcane crop located in the field of view.

11. A method of identifying, with an imaging device, the planting of sugarcane billets deposited in a field by a sugarcane planter, the method comprising:
cutting a trench in a field with a trencher;
depositing the sugarcane billets into the trench from a hopper of the sugarcane planter;
adjusting an amount of ambient light in the trench;
imaging, with the adjusted amount of ambient light, the sugarcane deposited in the trench as the hopper moves along the field to provide one or more images of the deposited sugarcane; and
identifying one or more planting characteristics of the deposited sugarcane billets based on the provided one or more images.

12. The method of claim 11 further comprising identifying a quantity of sugarcane billets planted in a trench over a portion of the trench.

13. The method of claim 12 further comprising identifying a planting rate of the sugarcane billets based on the provided one or more images.

14. The method of claim 13 wherein imaging the sugarcane includes imaging the sugarcane with an imaging device having a field of view configured to image a portion of the trench.

15. The method of claim 14 wherein adjusting the amount of ambient light at the trench includes shading the amount of ambient light received by the imaging device.

16. The method of claim 15 wherein shading the amount of ambient light received by the imaging device includes using a movable light deflector configured to deflect ambient light from the imaging device.

17. The method of claim 16 further comprising imaging the sugarcane deposited in the trench with a light source directed to the field of view.

18. An agricultural machine for planting sugarcane in a field, the agricultural machine comprising:
a power mover;
a hopper, coupled to the power mover, the hopper configured to carry cut sugarcane;
a trencher operatively connected to a frame of the agricultural machine and configured to form a trench in the field;
a dispensing chute operatively connected to the hopper, the dispensing chute configured to dispense the cut sugarcane from the hopper to the trench; and
an imaging system supported by the trencher, wherein the imaging system includes a field of view within the trencher and the field of view is directed toward the cut sugarcane dispensed in the trench.

19. The agricultural machine of claim 18 wherein the imaging system includes an imaging device and a light source configured to emit light to illuminate the field of view.

20. The agricultural machine of claim 19 wherein the imaging system includes at least one movable light deflector, wherein the at least one movable light deflector is configured to move in response to contact with the field or in response to contact with cut sugarcane dispensed in the trench.
